(19) United States
(12) Patent Application Publication
(10) Pub. No.: US 2024/0287308 A1
(43) Pub. Date: Aug. 29, 2024

(54) ENHANCEMENT OF HIGH TEMPERATURE RESISTANCE OF ASPHALT BINDERS MODIFIED WITH LDPE/RPE AND SULFUR

(71) Applicant: Qatar Foundation for Education, Science and Community Development, Doha (QA)

(72) Inventors: Eyad Masad, Doha (QA); Lakshmi Roja Kakumanu, Doha (QA); Ahmed Abdala, Doha (QA); Mabrouk Ouederni, Doha (QA); Siavash Barmand, Doha (QA); Oluwagbemi Banji Ibikunle, Cambridgeshire (QA)

(21) Appl. No.: 18/576,061

(22) PCT Filed: Jul. 6, 2022
(86) PCT No.: PCT/QA2022/050014

§ 371 Date: Jan. 2, 2024

Related U.S. Application Data
(60) Provisional application No. 63/218,700, filed on Jul. 6, 2021.

(51) Int. Cl. C08L 95/00; C08J 3/20; C08K 3/06

(52) U.S. Cl. CPC C08L 95/00; C08J 3/201; C08K 3/06; C08J 2395/00; C08J 2423/06; C08L 2207/066; C08L 2555/54

(57) ABSTRACT

An asphalt binder composition includes a base asphalt binder, low-density polyethylene (LDPE), and sulfur. The LDPE includes LDPE 70. The base asphalt binder is blended with the LDPE and the sulfur.

### PRIORITY CLAIM

The present application claims priority to and the benefit of U.S. Provisional Patent Applications No. 63/218,700, filed on Jul. 6, 2021, the entirety of which is incorporated herein by reference.

### BACKGROUND

Asphalt is a common material used in the construction of roads and a key component of asphalt is the asphalt binder. In high-temperatures environments, such as Qatar, a binder with a high temperature grade is needed to ensure adequate performance. Asphalt can be modified using plastics, such as polyethylene (PE). However, the modification of asphalt using PE along may require continuous agitation to prevent separation of PE from asphalt until asphalt mixture is laid.

### SUMMARY

The present disclosure generally relates to asphalt binders modified with low-density polyethylene (LDPE)/recycled polyethylene (RPE) and sulfur.

In light of the present disclosure, and without limiting the scope of the disclosure in any way, in an aspect of the present disclosure, which may be combined with any other aspect listed herein unless specified otherwise, an asphalt binder composition for enhanced high temperature resistance is provided. The asphalt binder composition may include a base asphalt binder, low-density polyethylene (LDPE), and sulfur.

In light of the present disclosure, and without limiting the scope of the disclosure in any way, in an aspect of the present disclosure, which may be combined with any other aspect listed herein unless specified otherwise, an asphalt binder composition for enhanced high temperature resistance is provided. The asphalt binder composition may include a base asphalt binder, RPE, and sulfur.

In light of the present disclosure, and without limiting the scope of the disclosure in any way, in an aspect of the present disclosure, which may be combined with any other aspect listed herein unless specified otherwise, a method of producing an asphalt binder composition is provided. The method includes providing a base asphalt binder, and blending the base asphalt binder with low-density polyethylene (LDPE) and sulfur.

In light of the present disclosure, and without limiting the scope of the disclosure in any way, in an aspect of the present disclosure, which may be combined with any other aspect listed herein unless specified otherwise, a method of producing an asphalt binder composition is provided. The method includes providing a base asphalt binder: blending the base asphalt binder with LDPE/RPE at a first predetermined temperature using a high shear mixer operating at a first rate for a first predetermined time to form a first blend; and blending the first blend with a sulfur at a second predetermined temperature using a low shear mixer operating at a second rate for a second predetermined time.

The reader will appreciate the foregoing details, as well as others, upon considering the following detailed description of certain non-limiting embodiments of the asphalt binder compositions and the method of producing the asphalt binder compositions according to the present disclosure.

### BRIEF DESCRIPTION OF THE FIGURES

FIG. 1 is a table with a list of test samples of Example 1 and BBR test results at 0° C.

FIGS. 2(a)-(g) illustrate DMT modulus maps of the samples of Examiner 1 in an unaged condition: (a) P6070; (b) 3L: (c) 5L: (d) 3L+S: (e) 3L+SBS+S: (f) 3L+E; and (g) 3L+E+P.

FIG. 3 is a graph showing DMT modulus average values of the samples of Example 1.

FIG. 4 is a graph showing a frequency sweep of |G*| in the continuous phase for the samples in Example 1.

FIG. 5 is a graph showing a frequency sweep of δ in the continuous phase for the samples in Example 1.

FIG. 6 is a graph showing a frequency sweep of |G*| in the dispersed phase for the samples in Example 1.

FIG. 7 is graph showing a frequency sweep of δ in the dispersed phase for the samples in Example 1.

FIG. 8 is a table showing the standard deviation of the samples in Example 1 at selected frequencies (|G*| in MPa & δ in degrees).

FIG. 9 is a graph showing a frequency sweep of |G*| at a bulk scale for the samples in Example 1.

FIG. 10 is a graph showing a frequency sweep of δ at a bulk scale for the samples in Example 1.

FIGS. 11(a)-(g) illustrate DMT modulus maps of the samples of Examiner 1 after long-term aging: (a) P6070; (b) 3L: (c) 5L: (d) 3L+S: (e) 3L+SBS+S: (f) 3L+E; and (g) 3L+E+P.

FIG. 12 is a graph showing that the average DMT modulus increases after long-term aging. The bar in the left represents the unaged condition, and the one in the right represents the long-term aged condition. The percentages represent the increase in the average DMT modulus values.

FIG. 13 is a black diagram for the sample blends in Example 1 containing additives in the continuous phase (continuous line) and dispersed phase (dashed line). |G*| and δ were obtained at a frequency of 1 Hz at 25° C. Arrow directions indicate aging progression.

FIG. 14 shows PG properties of the samples of Example 2.

FIG. 15 shows BBR test results of the samples of Example 2.

FIG. 16 shows the changes in viscosity of the samples of Example 3 according to the blending time.

FIG. 17 shows PG properties of the samples of Example 3.

FIG. 18 shows BBR test results of the samples of Example 3.

### DETAILED DESCRIPTION

The present disclosure generally relates to asphalt binder compositions and methods of producing the asphalt binder compositions for enhanced high temperature resistance. In particular, aspects of the present disclosure may be related to a development of a polymer-modified binder using LDPE or recycled polyethylene (RPE) (e.g., produced locally in Qatar), (2) the use of sulfur to improve the cross-linking and reduce the separation of LDPE/RPE from the binder, and (3) optimization of the blending conditions (e.g., LDPE/RPE properties, amount of sulfur, mixing time, mixing temperatures, and shearing rate) that may be needed to enhance the high temperature grade of the asphalt binder. The term LDPE/RPE as used herein may mean one or both of LDPE and RPE.

The use of modified asphalt binders in paving applications has been endorsed by roadway agencies because of the increase in traffic loads, the need to accommodate climatic conditions, and the increased focus on sustainability considerations. Polymer modified binders (PMBs) can enhance asphalt properties. Polymers used in asphalt modification can be categorized into three types: thermoplastic elastomers, plastomers, and reactive polymers.

Low-density polyethylene (LDPE) is a plastomer that can be used in asphalt modification. LDPE may improve the mechanical properties of the blends at higher temperatures. However, LDPE tends to crystallize, leading to low compatibility with asphalt due to differences in the polarity, aromaticity, molecular weight, and viscosity between the bitumen and LDPE. This low compatibility may cause storage instability, leading to phase separation, especially at elevated temperatures.

Aspects of the present disclosure may resolve the above-discussed issues in the related art, for example, by adding sulfur to the mix of the asphalt binder and the LDPE/RPE, which may increase the polarity and enhance the distribution of LDPE/RPE within the binder. Not wishing to be bound by theory, it is believed that sulfur does not chemically interact with LDPE/RPE, so its use in LDPE/RPE-modified binders may enhance LDPE/RPE distribution due to the physical interaction with the crosslinked asphalt network.

According to an embodiment, an asphalt binder composition is provided. In some examples, asphalt, LDPE (e.g., LDPE 70)/RPE, and sulfur may be used. In some examples, the LDPE may be not polyethylene wax. PE wax may refer to a very low molecular weight byproduct of the LDPE polymerization process (molecular weight: 6000). In some examples, optimum blending conditions may be adopted to complete the reaction process. The process may involve the blending of asphalt with LDPE/RPE and sulfur. In some examples, an optimum time (needed to enhance the reaction process while keeping the viscosity below the maximum limit) may be determined. In some examples, the following factors may control the achieved high binder grade: (1) properties of LDPE, (2) amount of LDPE, (3) amount of sulfur, and (4) blending process (shear rate and duration).

Aspects of the present disclosure may be able to increase the asphalt high temperature grade by two levels from PG 64 to PG76. Aspects of the present disclosure may be also able to increase the traffic designation of this grade from Standard (S) to Very Heavy (V). This may be a significant improvement in the binder grade and its performance in high-temperature environment. The increase in binder grade may improve its usability in regions with high temperatures (e.g., Qatar).

According to an embodiment, a method for producing an asphalt binder composition is provided. In some examples, the method according to the present disclosure may be a process to improve the temperature grade of asphalt binder. Specifically, the method may be an improved polymer-modified binder using LDPE/RPE, sulfur, and optimum blending conditions. LDPE (e.g., LDPE70) or RPE may be produced locally in regions with high temperatures (e.g., Qatar) and, therefore, may be readily available for use in asphalt binder production. When LDPE/RPE is combined with sulfur, the sulfur may improve the cross linking, which may reduce the separation of LDPE from the binder.

The method according to the present disclosure may also cover the optimum blending conditions needed to enhance the reaction process while keeping the viscosity below the maximum limit. Specifically, the method may control the following factors to improve the asphalt binder grade: (1) properties of LDPE/RPE, (2) amount of LDPE, (3) amount of sulfur, and (4) the shear rate and duration of the blending process. By controlling these factors, the method according to the present disclosure may increase the asphalt high temperature grade by two levels from PG 64 to PG76. The method according to the present disclosure may also increase the traffic designation of this grade from Standard (S) to Very Heavy (V).

In some examples, aspects of the present disclosure may provide an asphalt binder composition. The asphalt binder composition may include a base asphalt binder, LDPE, and sulfur. In some examples, the base asphalt binder may be a Pen 60-70 binder (i.e. Penetration 60-70). In other examples, the base asphalt binder may be any other suitable asphalt binder source and grade (e.g., PG 64-22, PG 64-16).

In some examples, the LDPE may be LDPE 70. As used herein, x in LDPE x may refer to the polymer Melt Flow Index (MFI). For example, LDPE70 has high MFI of 70 g/10 min. In other examples, the LDPE may be any other suitable LDPE, such as LDPE with a range of MFI between 0.1 and 80 g/10 min and density between 0.910 and 0.940 g/cm³ (e.g., a blend of LDPE sources).

In some examples, an amount of the LDPE in the asphalt binder composition may be in a range of about 1 wt. % to about 5 wt. % of the base asphalt binder, for example, about 2 wt. % to about 4 wt. %, about 2.5 wt. % to about 3.5 wt. %, about 2.8 wt. % to about 3.2 wt. %, or about 3 wt. %.

In some examples, an amount of the sulfur in the asphalt binder composition may be in a range of about 0.1 wt. % to about 0.4 wt. % of the base asphalt binder, for example, about 0.2 wt. % to about 0.3 wt. %, about 0.3 wt. % to about 0.35 wt. % about 0.35 wt. % to about 0.4 wt. %, or about 0.375 wt. %.

In some examples, the base asphalt binder may be blended with the LDPE and the sulfur. For examples, the base asphalt binder may be blended with the LDPE first (e.g., using a high shear mixer) and, then, the mix of the base asphalt binder and the LDPE may be blended with the sulfur (e.g., using a low shear mixer). The LDPE may be mixed with the base asphalt binder thoroughly prior to adding the sulfur, which may prevent freezing the blend's morphology due to crosslinking without homogeneous LDPE distribution.

In some examples, the base asphalt binder may be blended with the LDPE and the sulfur for a predetermined amount of time. The predetermined amount of time may be in a range of about 4 hours to about 25 hours. In some examples, the base asphalt binder may be blended with the LDPE and the sulfur at a temperature in a range of about 170° C. to about 190° C. In some examples, the base asphalt binder may be blended with the LDPE and the sulfur using a shear mixer operating at a rate in a range of about 500 rpm to about 2500 rpm.

In some examples, the asphalt binder composition does not include styrene-butadiene-styrene (SBS). SBS is a thermoplastic elastomer that consists of a hard thermoplastic styrene phase domain dispersed in a soft elastomeric butadiene phase that creates a three-dimensional stiff elastic network. When mixing with asphalt, the maltenes fraction in the asphalt is absorbed by butadiene, which makes it swell, creating a bulgy network that enhances the blend's elasticity and stiffness. However, there could be phase separation in SBS-modified asphalt at elevated temperatures. Also, sulfur added SBS-modified asphalt may show inadequate oxidative aging resistance.

In some examples, aspects of the present disclosure may provide an asphalt binder composition including a base asphalt binder, recycled polyethylene (RPE), and sulfur.

In some examples, the RPE may be RPE 15-M. RPE 15-M may have MFI of 1-4 gm/10 min. In other examples, the RPE may be any other suitable RPE, for example, RPE 12 (having MFI of 0.3-0.8 gm/10 min) or RPE 15-F (having MFI of 1-4 gm/10 min).

In some examples, an amount of the RPE in the asphalt binder composition may be in a range of about 2 wt. % to about 7 wt. % of the base asphalt binder, for example, about 3 wt. % to about 6 wt. %, about 3.5 wt. % to about 5.5 wt. %, about 4 wt. % to about 5.5 wt. %, about 4.5 wt. % to about 5.5 wt. %, about 4.8 wt. % to about 5.2 wt. %, or about 5 wt. %.

In some examples, an amount of the sulfur in the asphalt binder composition may be in a range of about 0.1 wt. % to about 0.4 wt. % of the base asphalt binder, for example, about 0.15 wt. % to about 0.25 wt. %, about 0.175 wt. % to about 0.225 wt. %, or about 0.2 wt. %.

In some examples, the base asphalt binder may be blended with the RPE and the sulfur. For examples, the base asphalt binder may be blended with the RPE first (e.g., using a high shear mixer) and, then, the mix of the base asphalt binder and the RPE may be blended with the sulfur (e.g., using a low shear mixer).

In some examples, the base asphalt binder may be blended with the RPE and the sulfur for a predetermined amount of time. The predetermined amount of time may be in a range of about 4 hours to about 15 hours. In some examples, the base asphalt binder may be blended with the RPE and the sulfur at a temperature in a range of about 170° C. to about 190° C. In some examples, the base asphalt binder may be blended with RPE and sulfur using a shear mixer operating at a rate in a range of about 500 rpm to about 2500 rpm.

Other configurations/features/characteristics of the asphalt binder composition (e.g., base asphalt binder material, the presence of SBS, etc.) may be similar to and/or same as the ones described above with respect to the asphalt binder composition (including LDPE) and, thus, duplicate description may be omitted.

In some examples, aspects of the present disclosure may provide a method of producing an asphalt binder composition, for example, by using LDPE. The method may include providing an base asphalt binder: blending the base asphalt binder with LDPE at a first predetermined temperature using a high shear mixer operating at a first rate for a first predetermined time to form a first blend; and blending the first blend with a sulfur at a second predetermined temperature using a low shear mixer operating at a second rate for a second predetermined time.

In some examples, the first predetermined temperature may be in range of about 170° C. to about 190° C., the first rate may be in range of about 1500 rpm to about 2500 rpm, and the first predetermined time may be in a range of about 0.5 hours to 1.5 hours. In some examples, the second predetermined temperature may be in range of about 170° C. to about 190° C., the second rate may be in range of about 500 rpm to about 1000 rpm, and the second predetermined time may be in a range of about 4 hours to 25 hours.

In some examples, aspects of the present disclosure may provide a method of producing an asphalt binder composition, for example, by using RPE. The method may include providing a base asphalt binder: blending the base asphalt binder with RPE at a first predetermined temperature using a high shear mixer operating at a first rate for a first predetermined time to form a first blend; and blending the first blend with a sulfur at a second predetermined temperature using a low shear mixer operating at a second rate for a second predetermined time.

In some examples, the first predetermined temperature may be in range of about 170° C. to about 190° C., the first rate may be in range of about 1500 rpm to about 2500 rpm, and the first predetermined time may be in a range of about 0.5 hours to 1.5 hours. In some examples, the second predetermined temperature may be in range of about 170° C. to about 190° C., the second rate may be in range of about 500 rpm to about 1000 rpm, and the second predetermined time may be in a range of about 4 hours to 15 hours.

Aspects of the present disclosure may use the appropriate materials (e.g., LDPE/RPE+sulfur) and blending process to improve the rheological properties of asphalt binders and increase their resistance to permanent deformation. Inventors have demonstrated through rheological tests that aspects of the present disclosure increase the asphalt high temperature grade from PG 64 to PG 76. That is, aspects of the present disclosure may be able to produce PG76V-10 asphalt binder from LDPE and sulfur.

### EXAMPLES

### Example 1

In this example/experiment, six blends containing different LDPE dosages and different additives were prepared. Regarding the sample preparation, the asphalt binder and LDPE were blended at 185° C. using a high shear mixer for a short duration (approximately 30 minutes). Subsequently, samples were transferred to a low shear mixer at a rate of 750 rpm. The duration of low shear mixing varied depending on the type of additives used. This procedure was carried out to ensure full dispersion of the LDPE particles into the asphalt binder. The dispersion of LDPE into the binder was additionally tested with optical microscopy.

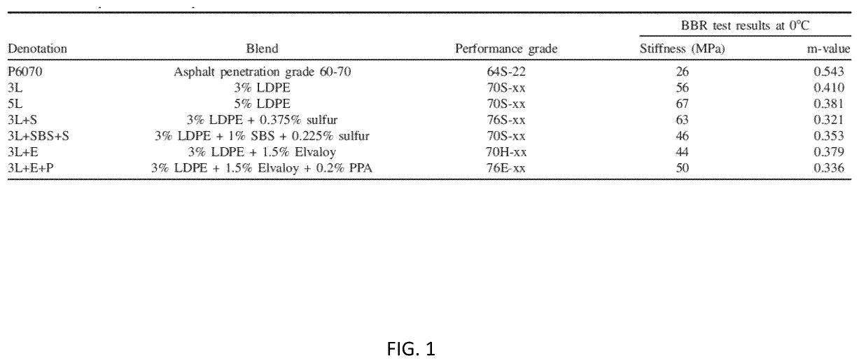

An unmodified penetration grade 60/70 (P6070) asphalt binder was used as a control sample and for all the modified binder samples. The table in FIG. 1 summarizes the seven blends included in this example. All modified blends were tested using the bending beam rheometer (BBR) test at 0° C. alone, and the results (listed in FIG. 1) verified that all blends met at least a low-temperature grade of −10° C., as required by Ministry of Municipality and Environment. The heat-casting approach was followed to prepare the AFM specimens. A small amount of the heated blend (around 150 mg) was poured and smeared on a glass slide, and the sample was then placed into an oven at 180° C. for 3 min until a uniform flat surface is noted. The samples were then cooled to room temperature and stored in a dark sealed storage unit for 24 h before testing.

### Dynamic Shear Rheometer

We used the DSR test to conduct frequency sweeps between 15 Hz and 1 Hz at a decrement rate of 1 Hz/s at a temperature of 25° C. following the AASHTO T315 standards. Each sample was tested twice for repeatability. The DSR test's outputs are the dynamic shear modulus (G*) and phase angle (δ). As discussed later, these bulk scale properties were compared with nanoscale viscoelastic properties acquired by the nDMA test.

### Atomic Force Microscopy (AFM)-PeakForce Quantitative Nanomechanical Mapping (PFQNM) Test

This experiment used Bruker's Dimension Icon AFM machine equipped with a nanoscope. The PFQNM test enables observation of samples' surface topography and calculation of their DMT (elastic) modulus value simultaneously. The tip used in this study was RTESPA-300-30. The PFQNM testing parameters are as follows: the peak force set point was set to 50 nN, the spring constant was 40 N/m, the tip radius was 30 nm, and the image resolution was 480×480. Testing was conducted at ambient temperature (˜25° C.), and scans were taken on three different locations on each sample to ensure repeatability.

AFM-Nanoscale Dynamic Mechanical Analysis (nDMA) Test

We captured the VE properties of the blends using the nDMA test at frequencies ranging from 1 Hz to 15 Hz. The nDMA test produces dynamic modulus (|E*|) and phase angle (8) values at a sweep of frequencies. We conducted the nDMA tests after the PFQNM test. In this work, frequency sweeps between 1 Hz and 15 Hz were performed at ambient temperature (˜25° C.). To ensure repeatability, at least 20 different locations within the continuous phase were tested for each sample, and at least 10 different locations within the dispersed phase were tested for each sample.

### Results and Discussion

The PFQNM test was used to observe the nanostructural changes and nanomechanical properties of the blends. One output of the PFQNM test is the DMT elastic modulus maps that provide the spatial distribution of the elastic modulus across the sample surface, which makes the PFQNM test appropriate for distinguishing the nanostructural phases while capturing their mechanical properties.

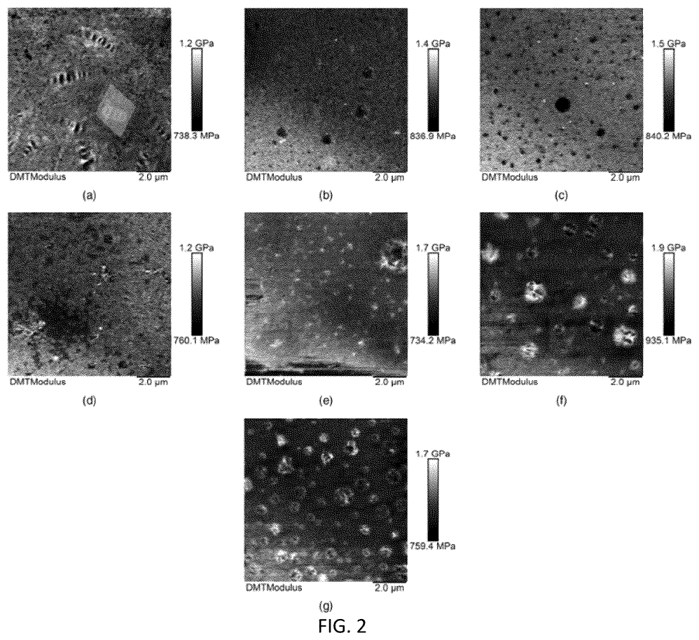

FIG. 2 shows the DMT modulus maps for all samples. The unmodified binder sample in FIG. 2(a) exhibits the three known nanoscale domains: the bee-like structure (Catana) domain in the shape of surface ripples consisting of peaks having the highest modulus value and valleys having the lowest values (indicated by the green area), surrounded by the interstitial (peri) domain that shows a slightly smaller modulus value compared to the peaks of the bees (indicated by the pink area), and a continuous matrix (para) domain surrounding both domains and showing an even smaller modulus than the peri domain. These domains may form due to the chemical heterogeneity of the binder at the nanoscale due to variances in the domains' polarity and intermolecular interactions. The bee-like structures may be thin films of crystallizable fractions (wax) that wrinkle on the binder surface upon cooling due to local compressive strains caused by thermal contractions and bending in the emerging crystal, thus emerging on the binder surface by means of surface (interfacial) tension.

Except for P6070, all modified binders exhibited two distinct phases: a continuous phase, which occupies most of the image area and is represented by the yellow-orange color, and a dispersed phase in the shape of local agglomerations distributed within the continuous phase represented by either a darker or brighter colors depending on the DMT modulus value. Upon modification, we noticed a complete disappearance of the bee-like structures. The exact reasoning behind this phenomenon is unclear. However, changes in polarity distribution and interfacial tension may occur after modification, causing these bee structures to be less apparent or vanish. In other words, the modification process may have reduced the incompatibility between the polar and nonpolar phases of the binders that is accountable for the evolution of the bee structures.

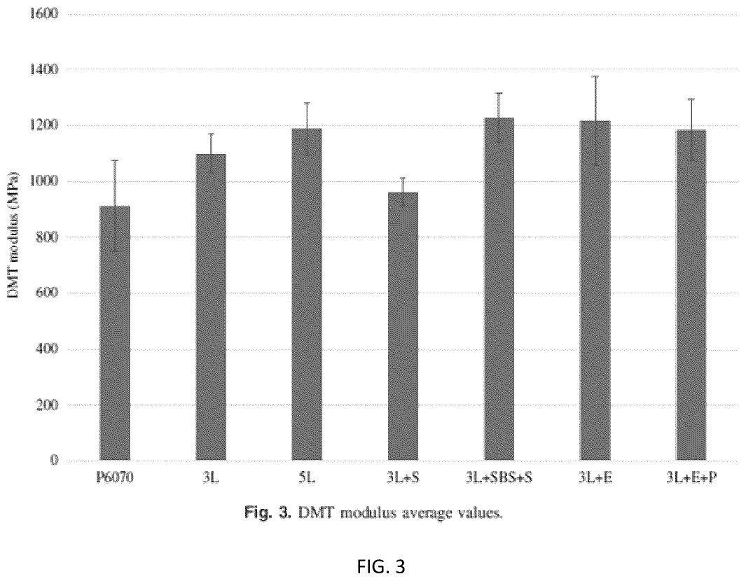

The modulus value increased after modification, as shown in the scale bars next to each DMT map and the average DMT modulus values in FIG. 3. The addition of LDPE on its own resulted in the appearance of a dispersed phase with lower modulus values (darker color), as indicated in blends 3L and 5L [FIGS. 2(b) and (c)]. The dispersed phase is believed to contain LDPE particles that did not fully integrate with the binder, resulting in their emergence on the blend's surface. Moreover, as the percentage of LDPE increased, the size and number of these areas increased, as shown for blend 5L. Moreover, FIG. 3 shows that the average modulus value increased with an increase in LDPE dosage.

Next, we will take a look at the effect of additives on the distribution and properties of LDPE-modified blends. The comparison will be carried out against sample 3L as it contains the same amount of LDPE as the other four blends containing additives. The nanostructural configuration in blend 3L+S [FIG. 2(d)] looks fairly complex, with the differentiation between the continuous and dispersed phases becoming less pronounced after sulfur addition. This can be attributed to the sulfur vulcanization (crosslinking) of the binder without causing a chemical reaction between sulfur and LDPE. The crosslinked binder network may exert pressure on LDPE particles, thus resulting in better dispersion of LDPE in the binder network. It is the physical interaction between LDPE particles and the crosslinked binder network that may enhance the polymer distribution and results in a more stabilized blend. Interestingly, this sample (3L+S) was the only one that exhibited a decreased DMT modulus value after modification when compared to sample 3L.

For the 3L+SBS+S blend shown in FIG. 2(e), the addition of SBS+sulfur appeared to significantly enhance the distribution of LDPE within the binder. This could be attributed to SBS increasing the blend's polarity. In addition to the crosslinking effect caused by the sulfur addition mentioned earlier, the presence of SBS in the blend may further promote the dispersion of LDPE particles due to the nature of the SBS chains. The long butadiene blocks are flexible, and the short styrene blocks are rigid. The flexible blocks are, to a certain extent, similar to the LDPE chains, and there is a certain level of compatibility between them. The physical interaction between LDPE particles and the crosslinked binder network observed in sample 3L+S is enhanced further by the rubbery butadiene blocks present in SBS. It is also reasonable to speculate that the continuous phase contains a blend of all four constituents as it occupies most of the map's area. Moreover, lighter-colored dispersions were detected. These locations could contain SBS particles, showing higher elasticity due to the formation of the 3D network between SBS and the binder.

For the 3L+E blend [FIG. 2(f)], the addition of Elvaloy induced the formation of dispersions with higher modulus values compared to the continuous phase. This is opposite to the samples containing LDPE only, which can be attributed to the chemical reaction generated by Elvaloy. Based on the modulus values, one can predict that these dispersions contain mainly LDPE particles that have chemically interacted with Elvaloy, whereas the continuous phase is a blend of the binder and LDPE. Adding Elvaloy was effective in bonding LDPE with the binder, which was indicated by the higher modulus value as seen in FIG. 3.

Adding PPA to the blend seems to enhance the distribution of Elvaloy within the binder, as seen in the 3L+E+P blend [FIG. 2(g)]. In that blend, the size of the dispersions seemed to decrease, and almost all of the dispersions exhibited a lighter color, indicating the absence of unblended LDPE particles. This could indicate the role of PPA in enhancing the distribution of Elvaloy within the binder incorporating more LDPE particles into the continuous phase.

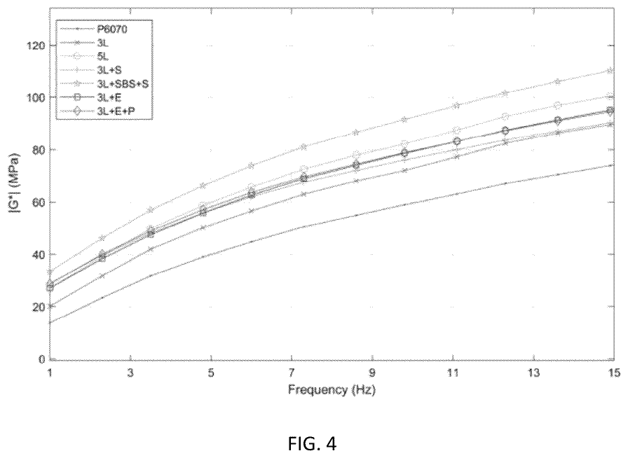

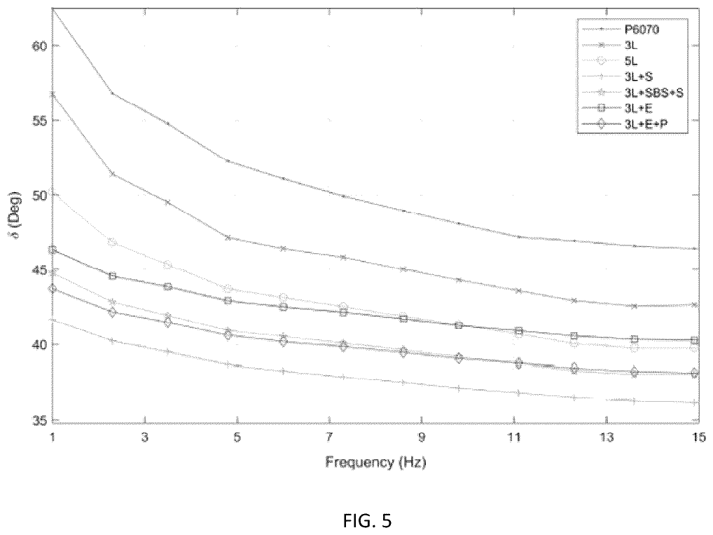

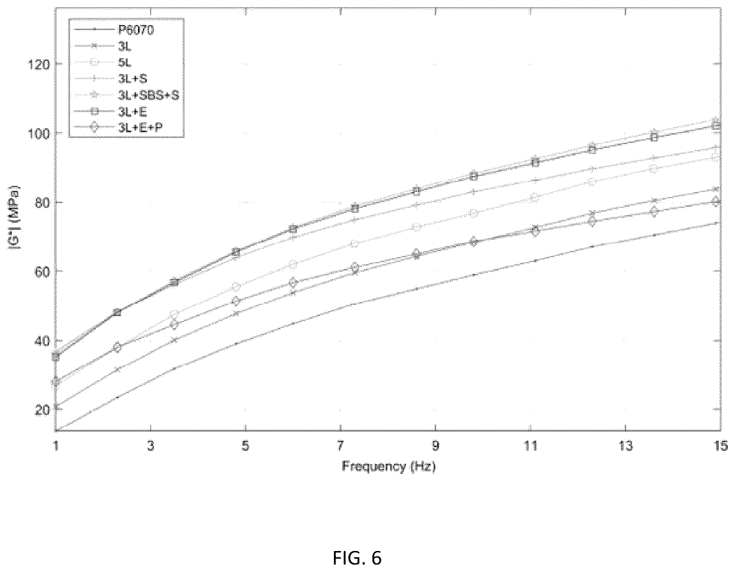

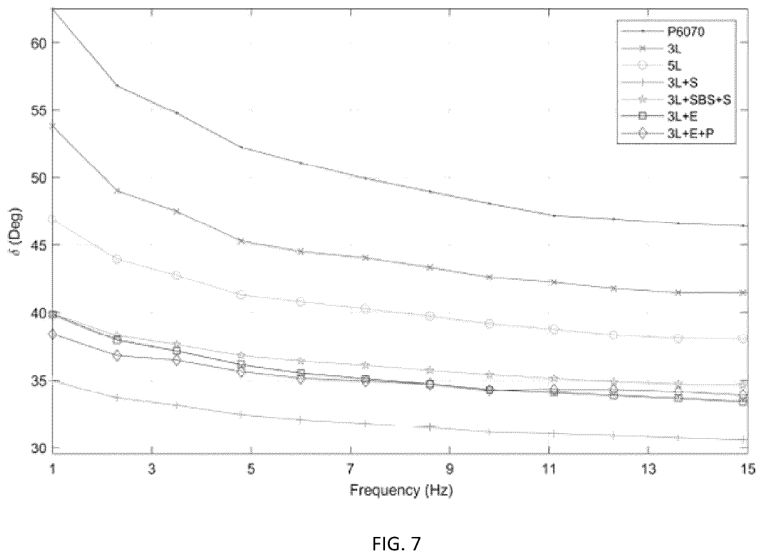

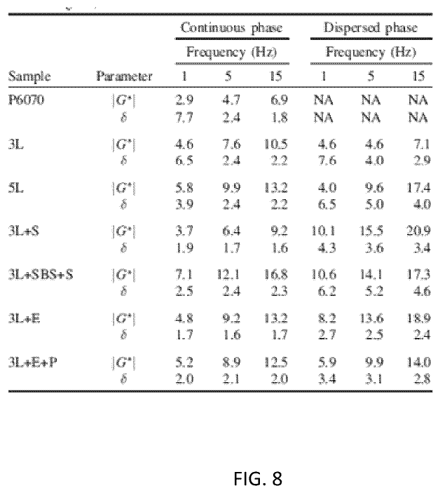

Following the PFQNM test, we conducted the nDMA test to obtain the linear VE properties of the blends. The PFQNM maps aid in selecting the locations of interest. Subsequently, we conducted nDMA frequency sweeps ranging between 1 Hz and 15 Hz at several randomly selected points within the continuous and dispersed phases. We basically studied each phase separately. Initially, we captured the VE properties of the selected points, and then we averaged the VE property at each frequency for all tested points within the same phase. FIGS. 4 and 5 show the |G*| and 8 frequency sweeps in the continuous phase, respectively, and FIGS. 6 and 7 show the |G*| and δ frequency sweeps in the dispersed phase, respectively. To account for variability within each phase, the table in FIG. 8 summarizes the standard deviation values at selected frequencies for each tested sample at each phase. The table shows that with an increase in frequency, variability in |G*| increases while variability in δ decreases.

The sweeps indicate that modification increased both the overall stiffness and elasticity of the blends, as all modified blends showed higher |G*| and lower δ values than the control sample. When comparing samples 3L and 5L, it can be noted that as LDPE dosage increased, both stiffness and elasticity increased. This was apparent in both the continuous and dispersed phases. Moreover, the PFQNM images could not differentiate between the behavior of samples 3L and 5L in the dispersed phases as they showed similar minimum modulus values; however, the nDMA test could detect the differences by exhibiting higher stiffness and lower phase angle values in sample 5L. Further, the dispersed phase in these two samples showed slightly lower (G*| and δ values when compared to the continuous phase, which is another indication that these locations contain mainly LDPE particles that were not fully blended with the binder.

Furthermore, the continuous phase in all samples showed a frequency-dependent behavior, where |G*| increased and δ values decreased with increasing frequency. This indicates that this phase contains mainly a VE material, i.e., asphalt binder. Interestingly, the rate of change of δ with frequency was also smaller for blends containing the additives. In the dispersed phase, |G*| values also exhibited frequency-dependent behavior. In contrast, the δ value was less dependent on frequency in the dispersed phase, especially at higher frequencies, implying that these locations could contain mainly LDPE particles and additives.

We also explored the effect of the different additives on blends' nanoscale VE properties at low and high frequencies and for each nanophase. In the continuous phase, where we believe that LDPE has integrated with the binder with the aid of the additives, blend 3L+SBS+S exhibited the highest stiffness among the four blends at both low and high frequencies. The blend also showed a decent elasticity enhancement: however, it did not have the lowest δ values. It appears that the combination of SBS and sulfur aided in bonding the LDPE particles with the crosslinked binder network, increasing the overall stiffness. The increase in stiffness is also consistent with the introduction of the rigid styrene blocks present in SBS. This also agrees with the corresponding PFQNM image. It is possible that the modest enhancement in elasticity could be improved if the SBS dosage were increased due to the elastomeric nature of SBS. Additional evidence of the small SBS dosage is that the rutting performance at high temperatures was unexpectedly low, as indicated in FIG. 1. In contrast, the dispersed phase showed a stiffer behavior at low frequencies and was less stiff at higher frequencies when compared to the continuous phase. In terms of elasticity, dispersions showed more elastic behavior compared to the continuous phase, implying the possible presence of SBS in the dispersion.

Blend 3L+E showed a fair improvement in stiffness and elasticity in the continuous phase and an even greater improvement in both properties in the dispersed phase. In other words, the interaction between Elvaloy and LDPE in the dispersed phase is more pronounced than the interaction with the binder in the continuous phase. This could probably explain the insignificant enhancement in the high-temperature grade shown in FIG. 1. Adding PPA to this blend slightly enhanced its stiffness and greatly improved the elasticity of the continuous phase. However, the dispersed phase in blend 3L+E+P showed a lower stiffness value than both its continuous phase and blend 3L+E. This could explain the role of PPA in enhancing the distribution of Elvaloy within the binder to incorporate more LDPE particles into the continuous phase. This would increase the bond between LDPE and the binder and result in higher stiffness and elasticity. This can also explain the enhancement in the high-temperature grade shown in FIG. 1.

Again, the complex nanostructural configuration of blend 3L+S made it difficult to differentiate between the continuous and dispersed phases. Nevertheless, there was a small to moderate improvement in stiffness in what is believed to be the continuous phase (lighter color regions). This may occur because sulfur may not chemically interact with LDPE. However, a considerable improvement in stiffness was noted in the dispersed phase (darker color regions) as these locations are predominated by LDPE particles. In contrast, a significant enhancement in elasticity was seen in both phases, which may be explained by the elastic network due to sulfur vulcanization.

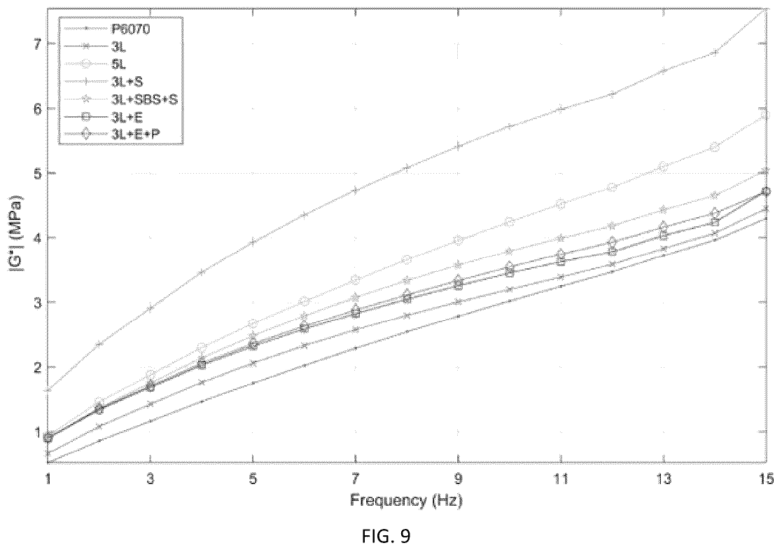

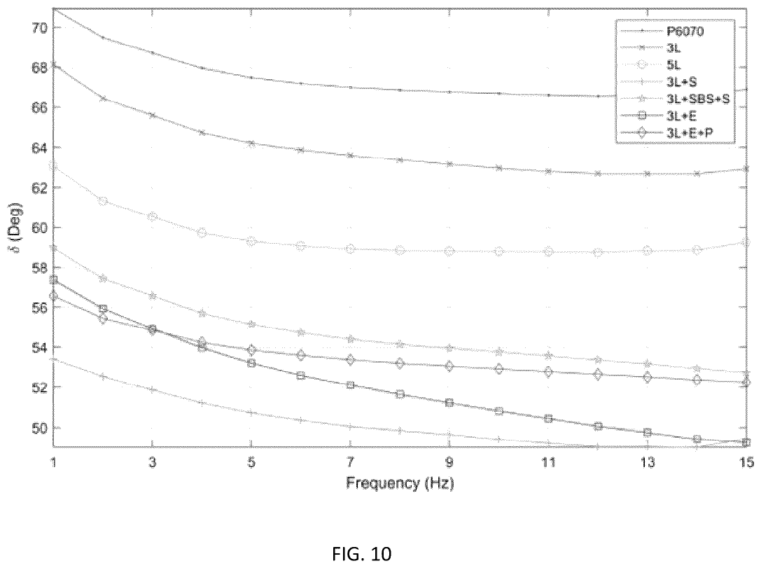

We also conducted frequency sweeps by means of DSR to obtain the VE properties of the blends at the bulk scale. The sweeps also ranged between 15 Hz and 1 Hz, with frequencies decreased at a rate of 1 Hz/s and were conducted at 25° C. The results obtained from the DSR was compared with the ones obtained from the nDMA tests. The DSR test generally captures the overall behavior of the blend and the nDMA test targets specific locations within the sample nanophases. FIGS. 9 and 10 show |G*| and δ frequency sweeps obtained by the DSR test. As in the nDMA test, all modified blends exhibited a higher stiffness and elasticity than the control sample. Also, as LDPE dosage increased, stiffness and elasticity increased, which is evident when comparing samples 3L and 5L.

We also studied the effect of different additives on bulk scale behavior. As shown in the figures, samples containing sole elemental sulfur showed the highest stiffness and elasticity increase among all blends. It appears that the DSR test captured the combined effect of all constituents at a larger scale than the nDMA test. The nDMA test could also detect these enhancements, especially in elasticity, but the detection was more pronounced at the bulk scale. Presumably, the scale of cross-linking in this blend was larger than the nDMA scale. The significant increase in stiffness is mostly attributed to LDPE particles that were not captured by the nDMA test, and the large increase in elasticity is also related to the elastic network created by sulfur vulcanization.

The DSR test demonstrated similar behavior in stiffness for blends 3L+E, and 3L+E+P. Blend 3L+SBS+S showed a slightly higher stiffness than those two blends. A similar trend was found by the nDMA test in the continuous phase, indicating that nanoscale properties will be projected at the bulk scale behavior. In contrast, the trend of elasticity was somewhat different from what was captured at the nanoscale, where it showed a slight increase in elasticity for blend 3L+SBS+S. Again, this could be attributed to the low dosage of SBS, as mentioned before. Lastly, all samples exhibited stiffer and more elastic behavior at the nanoscale, with higher |G*| and lower & values obtained when compared to the DSR test results.

We also investigated the effect of aging on the nanoscale properties, including the nanostructural and nanomechanical properties of the blends. To this end, we prepared and studied samples that were aged for a short period using the rolling thin film oven following the ASTM D2872-04 standards and then subjected to long-term aging using the pressure aging vessel test following the ASTM D6521-13 standards. The DMT modulus maps for the aged samples were utilized to study polymers' dispersity and their heat-induced separation tendency due to elevated temperatures applied during aging protocols. On the other hand, the nanoscale VE properties for the aged samples were used to study the impact of each additive on resisting oxidative aging.

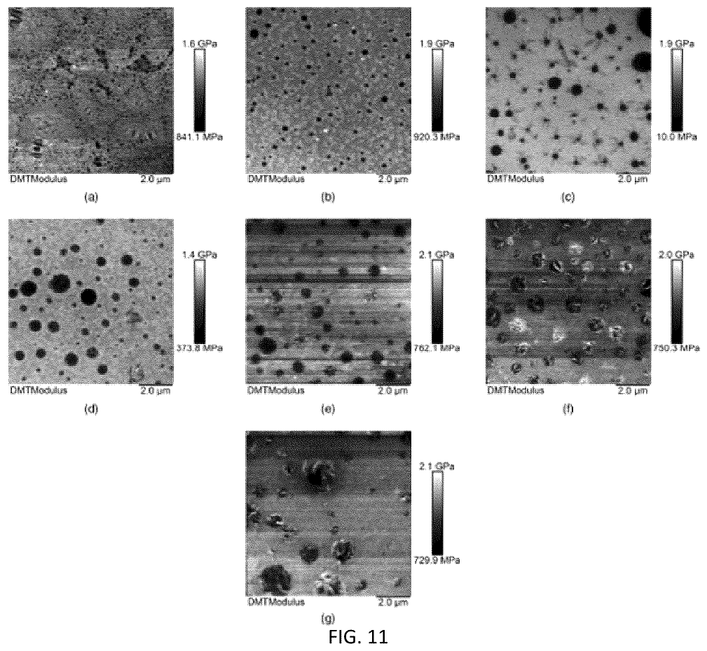

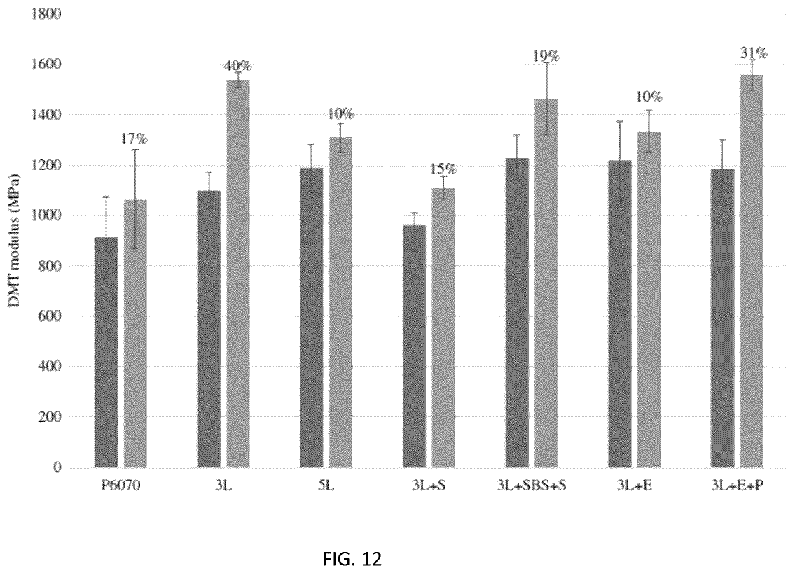

FIG. 11 shows the DMT modulus maps for the blends after aging. FIG. 12 shows the average DMT modulus values before and after aging and the percent increase after aging. Generally, aging increased the stiffness of the blends (i.e., increase in DMT values), as shown in both figures. Moreover, FIGS. 11(b) and (c) indicates that in blends containing sole LDPE, LDPE particles started to agglomerate forming larger dispersions with lower modulus values when compared to FIGS. 2(b) and (c), especially in blend 5L. This agglomeration was induced by the high temperatures used in aging protocols. Apparently, blending LDPE with asphalt becomes more challenging at higher dosages as the risk of heat-induced separation becomes higher.

Further, the emergence of large darker color dispersions was also observed in the sample containing elemental sulfur after aging, as indicated in FIG. 11(d). These dispersions could contain LDPE particles that agglomerated due to high heat during aging. Dispersions were not visible before aging in FIG. 2(d). Similar dispersions were observed in sample 3L+SBS+S [FIG. 11(e)], but with a slightly lighter color (higher modulus) indicating that some crosslinking is still present even after the exposure to heat. When blending sulfur with LDPE and asphalt blends, the blending procedure (dosages and durations) may play a vital role in the formation of proper cross-links. Sulfur may need be introduced to the blend when LDPE is homogeneously distributed in the binder to evade freezing the blend's morphology and thus producing a useless material. In the sample containing Elvaloy [FIG. 11(f)], the size of the dispersions seemed to decrease after aging when compared to FIG. 2(f). In addition, lighter color dispersions were still visible, indicating that crosslinking with LDPE is still present after aging. Lighter dispersions with higher modulus values were also observed in sample 3L+E+P [FIG. 11(g)]: however, the dispersions increased in size after aging. It appears that Elvaloy and Elvaloy+PPA are good options to resist heat-induced separation in LDPE blends, as crosslinking was still visible after heating during aging protocols.

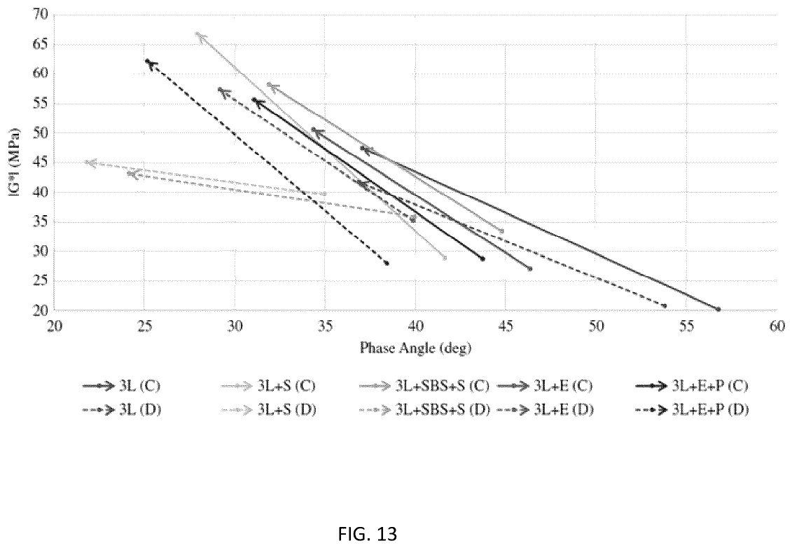

By comparing the VE properties before and after aging, we can assess the impact of each additive on oxidative aging resistance. FIG. 13 shows the Black diagram in the continuous and dispersed phases. |G*| and δ were obtained at a frequency of 1 Hz at 25° C. In the continuous phase, blends 3L and 3L+S exhibited the highest aging susceptibility, as evidenced by the largest increase in |G*| and decrease in δ after aging. Blend 3L+S also showed the highest stiffness after aging. In contrast, the other three blends showed a comparable aging resistance, with blend 3L+E exhibiting the lowest increase in |G*| and decrease in δ after aging. In the dispersed phase, which we believe is predominated by LDPE particles blended with additives, the behavior depicted may not necessarily indicate the effect of additives on binder aging resistance but may contribute to the overall behavior of the blend. As shown in FIG. 13, the behavior in the dispersed phase in blends 3L+S and 3L+SBS+S differed from behavior seen in the continuous phase where a minimum increase in stiffness was noted. In contrast, the behavior in the dispersed phase in blend 3L+E was the closest to the one depicted in the continuous phase.

### SUMMARY

This experiment in Example 1 aimed to explore the effects of various modifiers including SBS, elemental sulfur, Elvaloy, and PPA polymers on the nanostructural and nanomechanical (elastic and VE) properties of LDPE-modified binders. The experiment also investigated the effect of aging on the nano properties of such blends. The nanoscale results were further utilized to better understand and interpret the bulk scale properties measured by the DSR.

Modification of the binder used in this experiment completely altered binder nanostructure by reducing or eliminating the bee structures and creating two distinct phases: a continuous phase containing mainly binder fully bonded with LDPE and a dispersed phase containing unblended LDPE particles and additives. This phenomenon was verified by the PFQNM and nDMA tests. Moreover, modification increased the stiffness and elasticity of the blend, with higher dosages of LDPE resulting in higher stiffness and elasticity.

Blends containing Elvaloy and Elvaloy+PPA showed improved bonds between LDPE and the binder, which translated into an enhancement in the blends' stiffness and elasticity. The blend with PPA had an advantage, as it improved Elvaloy distribution within the binder. The enhancement in properties in both blends could be further improved by carefully increasing their dosages. The two blends also showed considerable resistance to heat-induced polymer separation and oxidative aging, with a slight advantage to the blend containing only Elvaloy.

Sulfur was effective in crosslinking the binder. It was also effective in stabilizing the blend by inducing physical interaction between LDPE particles and the crosslinked binder network. This resulted in significant improvements in the blend stiffness and elasticity, as evidenced by both the DSR and nDMA tests. However, these improvements were more pronounced in the bulk scale. Possibly, the scale of crosslinking in the blend was larger than the nDMA scale.

SBS+sulfur enhanced LDPE distribution within the binder, thus enhancing the blend's properties. On the other hand, a slight enhancement in elasticity was found, which could be improved by increasing SBS dosage. Moreover, the blend showed inadequate oxidative aging resistance. More detailed descriptions of the experiment conducted for Example 1 are disclosed in Aljarrah et al., “Nanostructural and Nanomechanical Properties of LDPE-Modified Binders,” J. Mater. Civ. Eng., 2022, 34(6): 04022081, which is herein incorporated by reference.

### Example 2

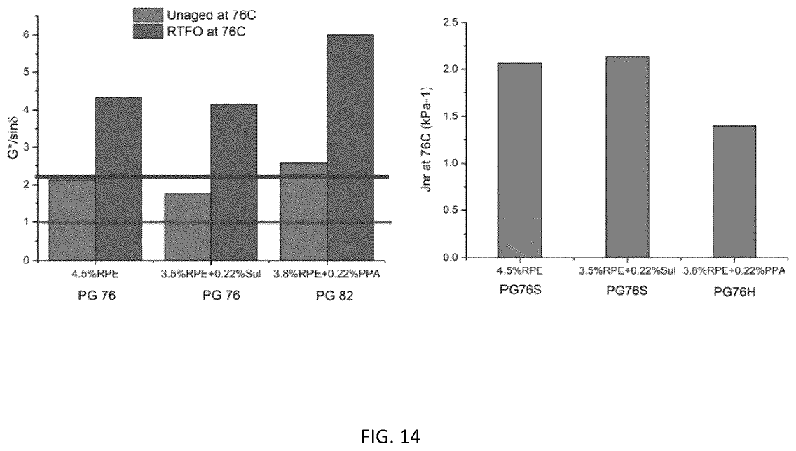

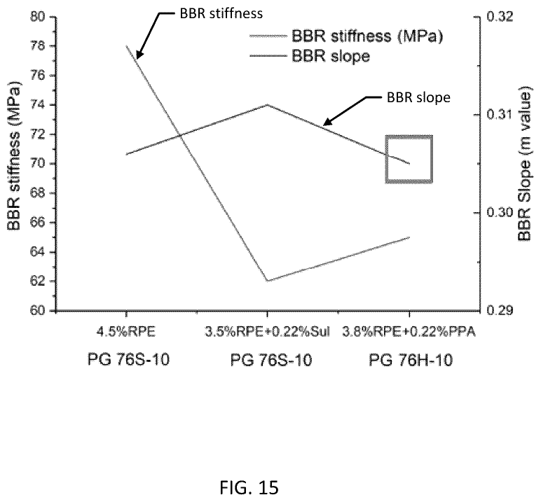

In this example/experiment, three blends containing different RPE dosages and different additives were prepared: Blend 1: 4.5% RPE: Blend 2: 3.5% RPE+0.22% Sulfur; and Blend 3: 3.8% RPE+0.22% PPA. These samples were blended for around 4-5 hours. We noticed issues when producing/testing Blend 3 because when the shearing stopped, the LDPE particles separated and formed a hard surface in the container. FIG. 14 shows the PG properties of the three blends. The addition of PPA increased the PG high temperature to 82 C. However, the RPE particles separated in a shorter time period and formed a hard surface on top of the container. FIG. 15 shows results of a BBR test over the three blends. All of the three blends were tested using the bending beam rheometer (BBR) test at 0° C., and the results verified that all blends met at least a low-temperature grade of −10° C., as required by Ministry of Municipality and Environment. When conducting a storage stability test, Blend 1 had 85% stability and Blend 2 had 97% stability. No DSR test could be conducted over Blend 3 because the top portion of the sample for Blend 3 was too stiff.

### Example 3

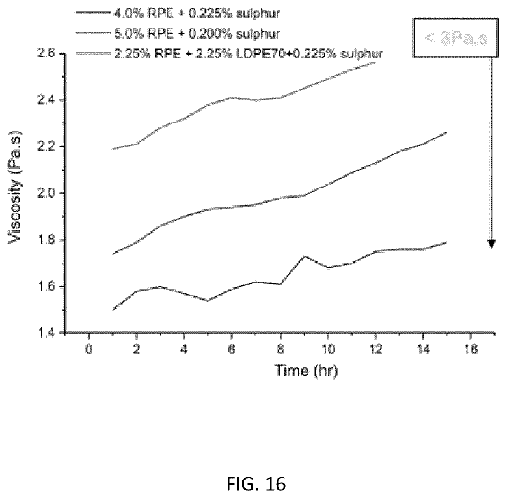

In this example/experiment, the following three blends were prepared: Blend 4: 4.0% RPE+0.225% Sulphur; Blend 5: 5.0% RPE+0.200% sulphur; and Blend 6: 2.25% RPE+2.25% LDPE70+0.225% sulphur. These samples were blended for around 12-15 hours (Blends 4 and 6: 15 hours, Blend 5: 12 hours). As shown in FIG. 16, for all of these blends, the viscosity value is less than 3 Pa·s at the end of curing time. Among these blends, for Blend 5, both PG and traffic grades were improved.

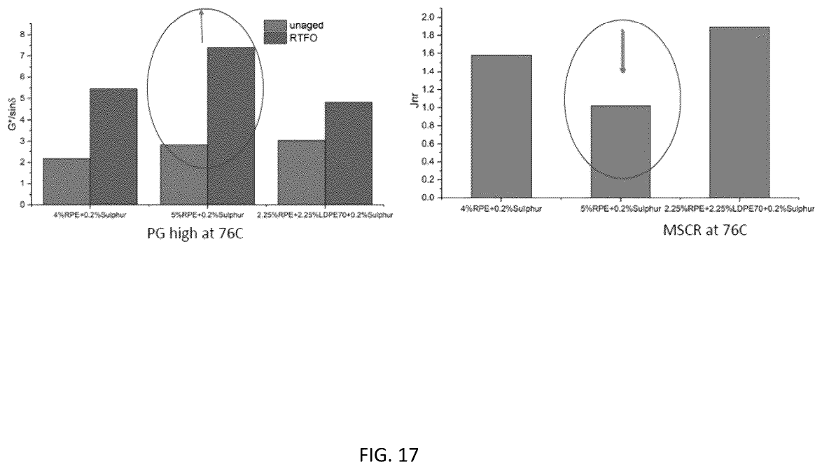

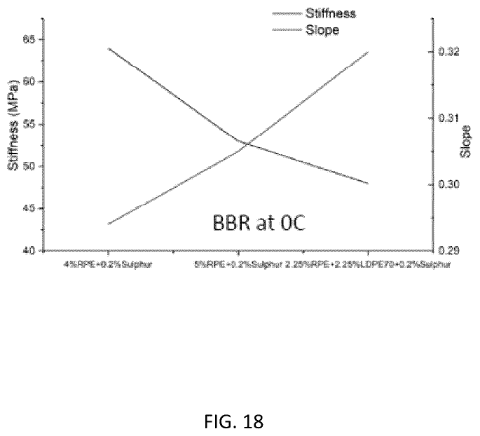

FIGS. 17 and 18 show the PG properties and BBR test results of the three blends. Among the three blends, Blend 5 (5% RPE+0.2% sulphur 12 hrs blending) improved the traffic grade to V. The use of higher RPE dosage and extended curing time seems to improve the PG properties and traffic grade in Blend 5. The viscosity of Blend 5 is less than 3 Pas (as required by Qatar Construction Specifications). This is sufficient to achieve the better pumpability/coatability of the asphalt mix. The storage stability of all three blends is higher than 90%. However, a continuous agitation can be given to the plant produced mix to homogenize the blend/avoid the phase separation.

As used herein, “about,” “approximately,” and “substantially” are understood to refer to numbers in a range of numerals, for example, the range of −10% to +10% of the referenced number, preferably-5% to +5% of the referenced number, more preferably-1% to +1% of the referenced number, most preferably-0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Reference throughout the specification to “various aspects,” “some aspects,” “some examples,” “other examples,” “some cases,” or “one aspect” means that a particular feature, structure, or characteristic described in connection with the aspect is included in at least one example. Thus, appearances of the phrases “in various aspects,” “in some aspects,” “certain embodiments,” “some examples,” “other examples,” “certain other embodiments,” “some cases,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

When the position relation between two parts is described using the terms such as “on,” “above,” “below,” “under,” and “next,” one or more parts may be positioned between the two parts unless the terms are used with the term “immediately” or “directly.” Similarly, as used herein, the terms “attachable,” “attached,” “connectable,” “connected,” or any similar terms may include directly or indirectly attachable, directly or indirectly attached, directly or indirectly connectable, and directly or indirectly connected.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but they do not preclude the presence or addition of one or more other features, integers, steps, operations, elements, components, and/or groups thereof. As used herein, the term “at least one of X or Y” or “at least one of X and Y” should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

1. An asphalt binder composition comprising:
a base asphalt binder;
low-density polyethylene (LDPE); and
sulfur.

2. The asphalt binder composition of claim 1, wherein the LDPE comprises LDPE 70.

3. The asphalt binder composition of claim 1, wherein an amount of the LDPE in the asphalt binder composition is in a range of about 1 wt. % to about 5 wt. % of the base asphalt binder.

4. The asphalt binder composition of claim 1, wherein an amount of the sulfur in the asphalt binder composition is in a range of about 0.1 wt. % to about 0.4 wt. % of the base asphalt binder.

5. The asphalt binder composition of claim 1, wherein the base asphalt binder is blended with the LDPE and the sulfur.

6. The asphalt binder composition of claim 1, wherein the base asphalt binder is blended with the LDPE and the sulfur for a predetermined amount of time, wherein the predetermined amount of time is in a range of about 4 hours to about 25 hours.

7. The asphalt binder composition of claim 1, wherein the base asphalt binder is blended with the LDPE and the sulfur at a temperature in a range of about 170° C. to about 190° C.

8. The asphalt binder composition of claim 1, wherein the base asphalt binder is blended with LDPE and the sulfur using a shear mixer operating at a rate in a range of about 500 rpm to about 2500 rpm.

9. The asphalt binder composition of claim 1, wherein the asphalt binder composition does not include styrene-butadiene-styrene (SBS).

10. An asphalt binder composition comprising:
a base asphalt binder;
recycled polyethylene (RPE); and
sulfur.

11. The asphalt binder composition of claim 10, wherein an amount of the RPE in the asphalt binder composition is in a range of about 2 wt. % to about 7 wt. % of the base asphalt binder.

12. The asphalt binder composition of claim 10, wherein an amount of the sulfur in the asphalt binder composition is in a range of about 0.1 wt. % to about 0.4 wt. % of the base asphalt binder.

13. The asphalt binder composition of claim 10, wherein the base asphalt binder is blended with the RPE and the sulfur.

14. The asphalt binder composition of claim 10, wherein the base asphalt binder is blended with the RPE and the sulfur for a predetermined amount of time, wherein the predetermined amount of time is in a range of about 4 hours to about 15 hours.

15. The asphalt binder composition of claim 10, wherein the base asphalt binder is blended with the RPE and the sulfur at a temperature in a range of about 170° C. to about 190° C.

16. The asphalt binder composition of claim 10, wherein the base asphalt binder is blended with the RPE and the sulfur using a shear mixer operating at a rate in a range of about 500 rpm to about 2500 rpm.

17. The asphalt binder composition of claim 10, wherein the asphalt binder composition does not include styrene-butadiene-styrene (SBS).

18. A method of producing an asphalt binder composition, the method comprising:
providing a base asphalt binder;
blending the base asphalt binder with low-density polyethylene (LDPE)/recycled polyethylene (RPE) at a first predetermined temperature using a high shear mixer operating at a first rate for a first predetermined time to form a first blend;
blending the first blend with a sulfur at a second predetermined temperature using a low shear mixer operating at a second rate for a second predetermined time.

19. The method of claim 18, wherein the first predetermined temperature is in range of about 170° C. to about 190° C., the first rate is in range of about 1500 rpm to about 2500 rpm, and the first predetermined time is in a range of about 0.5 hours to 1.5 hours.

20. The method of claim 18, wherein the second predetermined temperature is in range of about 170° C. to about 190° C., the second rate is in range of about 500 rpm to about 1000 rpm, and the second predetermined time is in a range of about 4 hours to 25 hours.
